(19) United States
(12) Patent Application Publication
(10) Pub. No.: US 2010/0055500 A1
(43) Pub. Date: Mar. 4, 2010

(54) OXIDE FINE PARTICLE POWDER AND PROCESS FOR ITS PRODUCTION, AND MAGNETIC RECORDING MEDIUM

(75) Inventors: Yoshiaki Nakagawa, Chou-ku (JP); Mamoru Satoh, Chou-ku (JP); Nobuhiro Jingu, Tokyo (JP)

Correspondence Address: DRINKER BIDDLE & REATH (DC), 1500 K STREET, N.W., SUITE 1100, WASHINGTON, DC, 20005-1209, US

(73) Assignee: TDK Corporation, Chuo-ku (JP)

(21) Appl. No.: 12/547,799

(22) Filed: Aug. 26, 2009

(30) Foreign Application Priority Data
Sep. 3, 2008 (JP) P2008-226235
May 29, 2009 (JP) P2009-130824
May 29, 2009 (JP) P2009-130827

(51) Int. Cl. G11B 5/33; B32B 1/00; C01G 49/02; C01G 23/04; C09K 11/78; C01G 53/04

(52) U.S. Cl. 428/800; 428/402; 423/594.2; 423/598; 252/301.4 R; 423/594.4

(57) ABSTRACT

The invention provides a process for production of an oxide fine particle powder including a heating step in which a dry powder of a metal complex gel is heat treated to obtain an oxide fine particle powder, wherein the heating step is carried out in two stages with different oxygen concentrations, or at least part of the heating step is carried out in a water vapor-containing atmosphere.

### BACKGROUND OF THE INVENTION

1. Field of the Invention

The present invention relates to an oxide fine particle powder and a process for its production, and to a magnetic recording medium.

2. Related Background Art

Metal oxide fine particle powders (oxide fine particle powders) are used as materials for many purposes including magnetic recording media, electrodes and catalysts. In recent years, oxide fine particle powders have become increasingly micronized to obtain enhanced properties, and processes for their production, such as gas phase synthesis processes and wet synthesis processes, have been proposed. However, while gas phase synthesis processes allow production of fine particles, the resulting particle size distribution is wide and yields are low, making such processes unsuitable for industrial production of fine particles.

Wet synthesis processes, on the other hand, allow mass production of fine particles of relatively uniform particle size, and are therefore anticipated as processes for production of oxide fine particle powders. However, conventional wet synthesis processes are associated with the following inconveniences.

Specifically, in wet synthesis processes the composition inside the obtained fine particles tends to be non-homogeneous, while the burden on the environment is increased when organic solvents are used, and the powder, when removed from the solvent, aggregates to form large, firm secondary particles instead of a satisfactorily dispersible powder. It is also known that heat treatment carried out to obtain desired crystal systems causes grain growth and sintering between particles, making it impossible to obtain small fine particles. In a coprecipitation process, as one type of wet synthesis process, segregation of the composition tends to occur when an alkali is used for the coprecipitation, or during drying or firing. This is thought to be the reason for the non-homogeneous composition in the fine particles.

In order to improve the non-homogeneity of the composition in such fine particles, it has been attempted to produce oxide fine particle powder by polymerized complex processes or by organic acid salt methods via organic acid salts, such as the citrate method. A polymerized complex process is a process in which a stable organometallic complex produced by a metal ion and organic acid is dissolved and dispersed in a polyhydric alcohol, and the solution is heated for condensation, after which the produced polymer is heat fired to obtain the desired metal oxide (see Japanese Unexamined Patent Publication HEI No. 08-290917). In this process, it is believed that the stabilized network structure of the high molecular metal complex and the low metal ion mobility inhibit aggregation and segregation of the metal elements during heated firing, so that the obtained fine particles have a homogeneous internal composition.

### SUMMARY OF THE INVENTION

Nevertheless, the organometallic complexes and polymers produced in the course of processes that involve metal complexes, such as the organic acid salt methods described above, contain large amounts of organic materials. The organic materials must therefore be degraded and removed in order to obtain oxide fine particle powder with reduced impurities. Degradation and removal of the organic materials is accomplished mainly by heat treatment such as combustion. However, such heat treatment often forms coarse particles in the obtained oxide fine particles. With conventional organic acid salt methods, therefore, it is still difficult to obtain oxide fine particle powder of uniform particle size, even though the overall particle sizes are small.

It is an object of the present invention to provide a process for production of oxide fine particle powder which can yield oxide fine particle powder with small particle diameters and uniform particle size, while also having a sufficiently low residual carbon content. It is another object of the invention to provide an oxide fine particle powder obtained by the production process and a magnetic recording medium comprising a magnetic layer which contains the oxide fine particle powder.

As a result of much diligent research directed toward achieving these objects, the present inventors have found that heating during degradation and removal of the organic material in organic acid salt methods causes local combustion of the organic material and increased temperature at those sections, thus promoting grain growth and producing coarse particles. Based on this knowledge, the present inventors have found that it is effective to conduct heat treatment under specific conditions, and have completed this invention.

According to a first aspect, the invention provides a process for production of oxide fine particle powder comprising a heating step in which a metal complex gel or dry organic acid salt powder is heat treated to obtain an oxide fine particle powder, wherein at least part of the heating step is carried out in a water vapor-containing atmosphere.

According to this production process, degradation and removal of the organic material is promoted while the residual carbon content is sufficiently reduced, so that an oxide fine particle powder with small particle diameters and uniform particle size can be obtained. The reason for this effect is not clearly understood. However, the present inventors conjecture that water vapor in the atmosphere promotes hydrolysis of the organic material, while acting as a catalyst to promote decomposition reactions other than hydrolysis and inhibiting combustion reaction of the organic material. This water vapor action allows the organic material to be satisfactorily removed while avoiding formation of coarse particles caused by local combustion of the organic material during the heating step. As a result, oxide fine particle powder with small particle diameters and uniform particle size can be obtained.

The water vapor-containing atmosphere for the heating step in the production process of the invention preferably also contains oxygen. This will further promote degradation of the organic material, to obtain an oxide fine particle powder with a sufficiently reduced residual carbon content. The heating temperature can also be lowered during heat treatment, thus allowing the particle diameter to be further reduced.

The dry powder is preferably subjected to heat treatment at 250-400° C. in the heating step of the production process of the invention. Heat treatment in this temperature range can more sufficiently remove the organic material, thus further inhibiting grain growth. It is thereby possible to achieve high levels of both residual carbon reduction and particle micronization.

The production process of the invention may also comprise a firing step in which the oxide fine particle powder obtained in the heating step is heat treated at a higher temperature than the heating step. Such heat treatment can alter the crystal structure to yield an oxide fine particle powder with the desired crystal structure.

According to a second aspect, the invention provides a process for production of oxide fine particle powder comprising a first step in which dry powder of a metal complex gel is heat treated in a first atmosphere to obtain fired powder, and a second step in which the fired powder is heat treated in a second atmosphere with a higher oxygen concentration than the first atmosphere to obtain oxide fine particle powder.

In the first step and second step of this production process, the dry powder of a metal complex gel is subjected to heat treatment in two stages in atmospheres with different oxygen concentrations, which are specifically a first atmosphere, and then a second atmosphere with a higher oxygen concentration. In the first step, heat treatment in the first atmosphere mainly causes degradation of the organic material in the dry powder of a metal complex gel. The second step mainly accomplishes removal (decarbonization) of the degraded organic material (carbon, etc.) remaining in the fired powder obtained from the first step.

Thus, this production process allows degradation and removal of the organic material in the dry powder of a metal complex gel to be accomplished under their respective suitable conditions by the first step and second step. In the first step, therefore, heat treatment is carried out under conditions with a lower oxygen concentration to cause degradation of the organic material while avoiding local temperature increase by oxidation of the organic material. In the second step, the carbon, etc. produced by degradation of the organic material is heat treated under conditions with a higher oxygen concentration than in the first step, so that efficient removal can be accomplished. Thus, in the heat treatment for degradation and removal of the organic material, the organic material can be satisfactorily removed while avoiding formation of coarse particles by local temperature increase. As a result, oxide fine particle powder with small particle diameters and uniform particle size can be obtained.

In the first step of the process for production of oxide fine particle powder according to the invention, the oxygen concentration in the first atmosphere is preferably 0-2000 ppm and the dry powder of a metal complex gel is preferably heated at 200-500° C. If the first step is carried out under these conditions, it will be possible to sufficiently promote degradation of the organic material while more satisfactorily inhibiting local temperature increase accompanied by oxidation of the organic material in the dry powder of a metal complex gel.

More preferably, in the first step, the oxygen concentration in the first atmosphere is 0-50 ppm and the dry powder of a metal complex gel is heated at 200-300° C. With a low (50 ppm or lower) oxygen concentration in the first atmosphere, it will be possible to lower the heating temperature in the first step, thus preventing local heat release caused by oxidation of the organic material. This can reduce the size of the product of the first step to an unmeasurably small particle size. As a result, oxide fine particle powder with even smaller particle diameters can be obtained from the second step.

The first fired powder is preferably heated to 300-500° C. in the second step. Heating at such a temperature in an atmosphere with a higher oxygen concentration than in the first step can more efficiently remove the degraded organic material (carbon, etc.).

The production process described above may also comprise a third step in which the oxide fine particle powder obtained from the second step is subjected to further heat treatment to avoid grain growth. Such heat treatment will give the oxide fine particle powder a suitable phase structure after the second step.

According to a third aspect of the invention there is provided oxide fine particle powder obtained by either of the processes for production of oxide fine particle powder described above. Since the oxide fine particle powder is obtained by a production process characterized as described above, the particle diameters are small and the particle size is uniform. Various effects can be obtained with such oxide fine particle powder, depending on the use. For example, when the oxide fine particle powder is applied as a material for a magnetic tape, the small particle diameters and homogeneity allow high recording density to be achieved. Damage to reading heads by protrusion of coarse particles can also be minimized. When applied as a catalyst, the oxide fine particle powder can exhibit high catalytic activity due to its large surface area formed by fine and uniform particles.

Specifically, oxide fine particle powder obtained by either of the production processes described above has a primary particle with a mean particle diameter of 1-50 nm and contains no particles with particle diameters exceeding 100 nm, while the specific surface area is 30 m²/g or greater and the carbon content is no greater than 0.5 wt %.

According to a fourth aspect of the invention there is provided a magnetic recording medium comprising a magnetic layer that contains the aforementioned oxide fine particle powder. The magnetic recording medium has high recording density because it employs fine, uniform oxide fine particle powder as the magnetic powder.

As mentioned above, the present invention can provide a process for production of oxide fine particle powder via a metal complex, to obtain oxide fine particle powder with small particle diameters and uniform particle size, while also having a sufficiently low residual carbon content. It can further provide an oxide fine particle powder obtained by the production process. It can also provide a magnetic recording medium having high recording density, comprising a magnetic layer containing the oxide fine particle powder.

### BRIEF DESCRIPTION OF THE DRAWINGS

FIG. 1 is a schematic cross-sectional view of magnetic tape as an embodiment of a magnetic recording medium according to the invention.

FIG. 2 is a TEM photograph of the strontium ferrite powder obtained in Example 10.

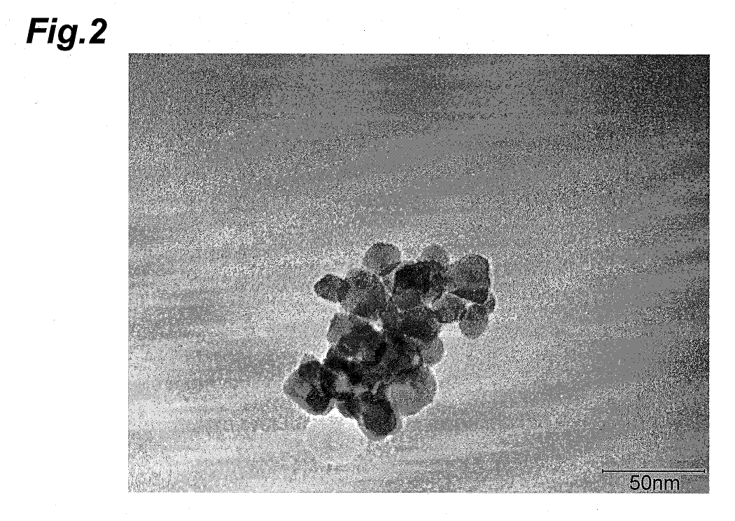

FIG. 3 is a TEM photograph of the strontium ferrite powder obtained in Comparative Example 3.

### DESCRIPTION OF THE PREFERRED EMBODIMENTS

Preferred embodiments of the invention will now be described in detail.

### First Embodiment

The process for production of oxide fine particle powder according to this embodiment comprises a mixing step in which a metal oxide starting mixture is prepared, a solution preparation step in which a metal organic acid salt solution containing a metal complex (metal organic acid salt) is obtained as a complex of metal and an organic acid in the starting mixture, a gel-forming step in which a metal complex gel is formed from the metal organic acid salt solution, a heating step in which the dry powder of a metal complex gel is heat treated in a water vapor-containing atmosphere to obtain a fired powder, and a firing step in which the fired powder is heat treated at a higher temperature than the heating step to obtain oxide fine particle powder. Each of these steps will now be explained in detail.

In the mixing step, a metal oxide starting mixture is prepared. The metal oxide starting mixture may be an aqueous solution comprising salts of the metals for the desired metal oxide, dissolved or dispersed in water or the like. The metal salts are not particularly restricted so long as they can form salts (complexes) with organic acids as described hereunder, and nitric acid salts may be mentioned as examples.

In the solution preparation step, an organic acid, for example, is mixed with the starting mixture to obtain a metal organic acid salt solution containing metal complexes (metal organic acid salts) formed by the metals and organic acid in the starting mixture. The organic acid used is preferably a polyvalent carboxylic acid. As examples of preferred carboxylic acids there may be mentioned citric acid, oxalic acid and succinic acid. The starting mixture and organic acid may be mixed by stirring in a solvent, for example. When a polyhydric alcohol is used for gelling as described hereunder, for example, the polyhydric alcohol may be added at this stage as a solvent. According to this embodiment it is not necessary to synthesize the metal complexes in this manner, and previously prepared metal complexes may be used.

In the gel-forming step, a metal complex gel is formed from the metal organic acid salt solution prepared as described above. The metal complex gel may be obtained by heating the metal organic acid salt solution if the metal complexes directly form a gel, as when oxalic acid is used as the organic acid, for example.

When direct gelling of the metal complexes does not occur, as when citric acid is used as the organic acid, a polyhydric alcohol may be added for ester polymerization between the polyhydric alcohol and organic acid, to produce a metal complex gel. In this case, the metal complex gel may be obtained by adding the polyhydric alcohol to the metal organic acid salt solution for dissolution, and then concentrating and heating the solution to produce polymerization reaction. The polymerization reaction may be carried out while stirring the solution. However, in order to allow the viscosity of the solution to increase as the polymerization reaction proceeds, stirring is preferably interrupted at an appropriate timing, allowing polymerization to proceed by heating alone. The metal complex gel is not limited to one composed of metal organic acid salts as described above. For example, it may be prepared by adding only a polyhydric alcohol or the like to the starting mixture, without using an organic acid.

As polyhydric alcohols there may be used, for example, ethylene glycol, 1,3-propanediol, 1,2-propanediol, 1,4-butanediol, 1,3-butanediol, 1,2-butanediol, 2,3-butanediol, 1,5-pentanediol, 1,2-pentanediol, 2,4-pentanediol, 1,6-hexanediol, 1,2-hexanediol, 2,5-hexanediol, 1,7-heptanediol, 1,8-octanediol, 1,9-nonanediol, glycerin and pentaerythritol.

The obtained metal complex gel may be dried and pulverized to prepare a dry powder of a metal complex gel. For example, the metal complex gel produced by the step described above may be cooled to room temperature to form a mass and pulverized to obtain dry powder. A “dry powder” of the metal complex gel is any powder state containing virtually no solvents or the like, and it does not have to be obtained by drying treatment.

In the heating step, the dry powder of a metal complex gel is heat treated in a water vapor-containing atmosphere to obtain a fired powder. The heat treatment in the heating step degrades and removes the organic material in the dry powder of the metal complex gel. The organic material referred to here includes the organic acids, polyhydric alcohol polymers and the like.

The water vapor concentration in the atmosphere for heat treatment of the dry powder of a metal complex gel is preferably 20-80 vol %, more preferably 30-70 vol % and even more preferably 40-80 vol %. If the water vapor concentration is too high or too low, it will tend to be difficult to smoothly accomplish removal of the organic material. From the viewpoint of inhibiting adhesion of water in the furnace and further promoting degradation and removal of the organic material, the water vapor is preferably superheated steam.

The heat treatment is preferably carried out in a mixed gas atmosphere containing water vapor and oxygen. Such mixed gas can be obtained, for example, by mixing water vapor and air in a prescribed proportion. This will result in smooth removal of the organic material by the synergistic action of water vapor-promoted degradation and oxygen-promoted degradation of the organic material. It will thus be possible to obtain an oxide fine particle powder with more satisfactorily reduced impurities such as residual carbon. Moreover, since the heat treatment can be carried out at even lower temperature and in a shorter time, it will be possible to prepare oxide fine particle powder of finer more uniform particle size.

The oxygen concentration of the mixed gas atmosphere is preferably 0.1-15 vol % and more preferably 1-10 vol %. If the oxygen concentration is less than 0.1 vol % it will tend to be difficult to obtain a degrading effect on the organic material. If the oxygen concentration is greater than 15 vol %, on the other hand, the organic material will undergo partial combustion, thus promoting grain growth and tending to form coarse particles.

The water vapor does not need to be constantly present in the atmosphere during the heat treatment, and for example, the water vapor may be intermittently injected in the heating furnace for the heat treatment. That is, it is sufficient if at least part of the heating step is carried out in a water vapor-containing atmosphere for heat treatment of the dry powder of a metal complex gel. The oxygen concentration and water vapor concentration in the atmosphere may also be varied during the heat treatment.

The fired powder obtained in the heating step is oxide fine particle powder having a primary particle with a mean particle diameter in the range of, for example, 0.1-50 nm, and containing no coarse particles with particle diameters of greater than 100 nm. A firing step may also be carried out, in which the fired powder obtained in the heating step is heat treated at a higher temperature than the heating step.

In the firing step, heat treatment of the fired powder obtained from the heating step can yield oxide fine particle powder having a desired crystal structure. The firing step is effective for allowing removal of decomposition products of the organic material remaining in the fired powder, for example when firing has not proceeded sufficiently in the heating step.

In the firing step, the heat treatment is preferably conducted with as little grain growth as possible in order to maintain the fine and uniform particle diameters obtained in the heating step. The method used may be, for example, a method of rapidly increasing the temperature of the oxide fine particle powder to the desired peak temperature, and then rapidly lowering the temperature. Such a method allows mainly alteration of the phase structure of the crystals in the oxide fine particles, while minimizing grain growth.

The preferred conditions for the firing step are as follows. The temperature of the oxide fine particle powder is increased with temperature elevating rates of 0.5-600° C./sec. After then keeping it at a peak temperature of preferably 400-1200° C., more preferably 750-1200° C. and even more preferably 800-1000° C. for about 0-120 seconds, it is cooled with temperature lowering rates of 0.5-600° C./sec. The temperature lowering rate will vary more greatly nearer to room temperature, depending on the different heat quantities and thermal insulation properties of the furnaces used. The temperature lowering rate is therefore preferably set as appropriate for the properties of the furnace. If the temperature elevating and temperature lowering rates are slower than the aforementioned values, or the peak temperature is higher, then grain growth may occur, making it impossible to obtain oxide fine particle powder with small particle diameters.

### Second Embodiment

The process for production of oxide fine particle powder according to this embodiment comprises the same mixing step, solution preparation step and gel-forming step as the first embodiment. It also comprises a step of firing in two stages after the gel-forming step. The mixing step, solution preparation step and gel-forming step are the same as the first embodiment and will not be explained again here. After the gel-forming step, the first step, second step and if necessary third step described below are carried out.

<First Step>

In the first step, the dry powder of a metal complex gel is heat treated in a first atmosphere to obtain a fired powder. The first step is first-stage heat treatment of the metal complex gel, which primarily degrades the organic material in the dry powder of a metal complex gel, thus producing decomposition products (carbon, etc.) (organic material degradation and firing). The organic material referred to here includes the organic acids, polyhydric alcohol polymers and the like.

In the first step, heating is carried out in an atmosphere with a lower oxygen concentration than the second step described hereunder. The first atmosphere in the first step may contain oxygen. The oxygen concentration in the first atmosphere is, for example, preferably 0-2000 ppm, more preferably 50-2000 ppm, even more preferably 50-1000 ppm and most preferably 50-500 ppm. The heating temperature is preferably 200-500° C., more preferably 200-400° C., even more preferably 250-400° C., even yet more preferably 200-300° C., and most preferably 200-280° C.

Heat treatment of the dry powder of a metal complex gel under these conditions can cause partial oxidation (combustion) of the organic material in the dry powder by the excess oxygen, thus inhibiting local temperature increase. Normally, such local temperature increase promotes grain growth only at those sections, resulting in formation of coarse particles. In the first step, however, such local temperature increase is sufficiently prevented to yield fired powder of uniform particle size.

The fired powder obtained in the first step can serve as oxide fine particle powder having a primary particle with a mean particle diameter in the range of, for example, 1-50 nm, and containing no coarse particles with particle diameters of greater than 100 nm. Since the fired powder obtained in the first step is obtained by promoting firing of the dry powder of a metal complex gel by heat treatment in this step, it is composed mainly of metal oxide fine particles.

<Second Step>

In the second step, the fired powder obtained in the first step is heat treated in a second atmosphere with a higher oxygen concentration than the first atmosphere, to obtain oxide fine particle powder. In the second step, the decomposition products of the organic material (carbon, etc.) produced in the first step and remaining in the fired powder are oxidized and removed (decarbonizing firing).

The second atmosphere in the second step has a higher oxygen concentration than the first atmosphere in the first step. The second atmosphere has an oxygen concentration of, for example, preferably 20,000-400,000 ppm and more preferably 100,000-210,000 ppm. The second atmosphere may also be an atmosphere of air. The heating temperature in the second step is, for example, preferably 200-500° C., more preferably 200-400° C. and even more preferably 250-400° C. A second step satisfying these conditions can efficiently remove the decomposition products of the organic material.

Less of the organic material is left due to degradation in the first step, and therefore the main removal that occurs is oxidation of the decomposition product, such that the local temperature increase by combustion of the organic material that occurs in the first step does not readily occur in the second step. Also, since grain growth has already occurred by heating in the first step, grain growth is largely avoided in the second step. Consequently, fewer coarse particles are generated even though the second step employs an atmosphere with a higher oxygen concentration than the first step, and the decomposition products of the organic material can thus be efficiently removed by the high oxygen concentration.

Degradation and removal of the organic material do not necessarily need to be accomplished separately in the first step and second step. For example, degradation of the organic material may occur in the second step even if removal of decomposition products of the organic material has already proceeded in the first step. However, since the oxygen concentrations in the first step and second step differ for this embodiment, degradation of the organic material occurs preferentially in the first step while removal of the decomposition products occurs preferentially in the second step.

Heat treatment of the dry powder of a metal complex gel in the first and second steps promotes firing of the metal complex gel, yielding an oxide fine particle powder. At this stage, however, the firing may not have proceeded sufficiently and the particle crystals may not have a satisfactory phase structure. In such cases, the oxide fine particle powder obtained in the second step may be further subjected to heat treatment (main firing, or third step) to obtain oxide fine particle powder having the desired phase structure.

<Third Step>

In the third step, the heat treatment is preferably conducted with as little grain growth as possible in order to maintain the fine and uniform particle diameters obtained in the second step. The method used may be, for example, a method of rapidly increasing the temperature of the oxide fine particle powder to the desired peak temperature, and then rapidly lowering the temperature. Such a method allows the phase structure of the crystals in the fine particles to be altered while minimizing grain growth.

The following conditions are preferred for the third step. The temperature of the oxide fine particle powder is raised with temperature elevating conditions of 0.5-600° C./sec, and kept at a peak temperature of preferably 400-1200° C., more preferably 750-1200° C. and even more preferably 800-1000° C. for about 0-120 seconds. It is then cooled with temperature lowering conditions of 0.5-600° C./sec. The temperature lowering rate will tend to vary more greatly nearer to room temperature, depending on the different heat quantities and thermal insulation properties of the furnaces used. It is therefore preferably set as appropriate for the properties of the furnace. If the temperature elevating and temperature lowering rates are slower than the aforementioned conditions, or the peak temperature is higher, then grain growth may occur, making it impossible to obtain oxide fine particle powder with small particle diameters.

A preferred embodiment of the oxide fine particle powder will now be explained. The oxide fine particle powder of this embodiment can be obtained by the production process of the first embodiment or second embodiment described above. The oxide fine particle powder has small particle diameters and a uniform particle size. A mean particle diameter of a primary particle of the oxide fine particle powder is preferably 0.1-50 nm and more preferably 0.1-40 nm. The oxide fine particle powder includes no coarse particles, such as particles with a particle diameter of greater than 100 nm or more preferably particles with a particle diameter of greater than 80 nm.

The specific surface area of the oxide fine particle powder is preferably 30 m²/g or greater and more preferably 35-120 m²/g. The particle diameter of the oxide fine particle powder may be measured by, for example, TEM observation, and the specific surface area by the BET method. The particle diameter value used may be, for example, the arithmetic mean value for the measured particle diameters determined by observing at least 100 particles with by TEM.

Since the oxide fine particle powder obtained by the production process of each embodiment described above is obtained by the aforementioned heat treatment, the amount of carbon from the organic material used in the production process is sufficiently reduced. Specifically, the carbon content of the oxide fine particle powder is preferably no greater than 0.5 wt % and more preferably no greater than 0.1 wt %.

Also, since the oxide fine particle powder characterized by having small particle diameters and a uniform particle size can exhibit excellent properties depending on the use, it is applicable for a variety of purposes.

Specifically, the oxide fine particle powder of this embodiment can be employed for various purposes, including as a catalyst material to be used for degradation and purification of automobile exhaust gas or hazardous substances, a dielectric material to be used in a condenser or the like, a fluorescent material to be used in a display or LED, a battery material to be used in a cell electrode or fuel cell electrolyte or the like, a polishing agent such as an abrasive for chemical mechanical polishing (CMP), a sensor material such as a high-sensitivity gas sensor, a conductive material in a transparent electrode or the like, an ultraviolet-blocking material to be used in cosmetics or ultraviolet-blocking glass or the like, or a superconducting material applicable as an oxide superconductor.

The composition of the oxide fine particle powder can be appropriately selected according to the particular use, and is not particularly restricted so long as the fine particles can be produced by a production process according to the embodiments described above. For example, there may be used various oxides such as ferrite magnetic materials, barium titanate dielectric materials, cerium-zirconium complex oxide automobile exhaust gas catalyst materials, lithium nickelate cell materials and yttrium-based oxide superconducting materials.

Preferred modes of the magnetic recording medium of the invention will now be explained.

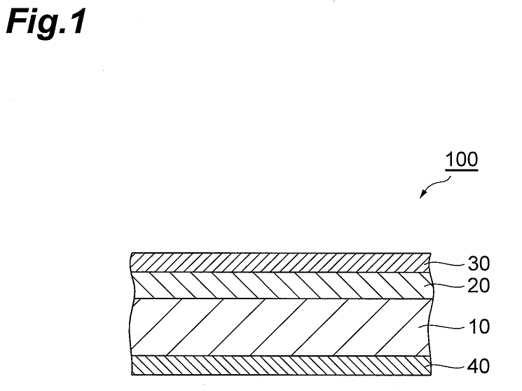

FIG. 1 is a schematic cross-sectional view of magnetic tape as an embodiment of a magnetic recording medium according to the invention. The magnetic tape 100 shown in FIG. 1 comprises a non-magnetic layer 20 and magnetic layer 30 laminated on one side of a tape-like support 10 in that order from the support 10 side, and a backcoat layer 40 laminated on the other side of the support 10.

As the support 10 there may be used a resin film, such as a film of a polyester resin such as polyethylene terephthalate or polyethylene naphthalate, or of a polyamide, polyimide or polyamideimide.

The non-magnetic layer 20 and backcoat layer 40 may be formed on the support 10 by a method normally employed for production of magnetic tapes. For example, the non-magnetic layer 20 may be formed by coating the support 10 with a non-magnetic coating material comprising non-magnetic particles, a binder, and if necessary other components such as a dispersing agent, polishing agent and lubricant. As non-magnetic particles there may be used carbon black, α-iron oxide, titanium oxide, calcium carbonate, α-alumina, or mixtures of the foregoing. The backcoat layer 40 may be formed by coating the support 10 with a backcoat layer coating comprising carbon black or another non-magnetic inorganic powder, and a binder.

The magnetic layer 30 contains an oxide fine particle powder (for example, ferrite magnetic powder) according to the aforementioned embodiments. The magnetic layer 30 may be formed by the following procedure. First, a magnetic coating material containing an oxide fine particle powder and a binder is coated onto the non-magnetic layer 20 by an ordinary method to form a coated film. The magnetic coating material may also contain other components in addition to the binder, such as dispersing agents, lubricants, polishing agents, curing agents and antistatic agents. As specific examples of hydrophobic binders there may be mentioned thermosetting resins or radiation-curing resins, such as polyvinyl chloride-based polymer or copolymers, polyurethane-based resins, polyacrylic resins and polyester-based resins. As specific examples of hydrophilic binders there may be mentioned poly(N-vinyl-2-pyrrolidone), polyacrylic acid, polymaleic acid, polyglutamic acid and salts thereof, vinyl alcohol, polyethylene glycol, polypropylene glycol, polyacrylamide, polyvinylamine and polyethyleneimine, or derivatives or copolymers thereof, cellulose, water-soluble acrylic resins, water-soluble polyvinylacetals, water-soluble polyvinyl butyrals and water-soluble urethane resins.

After subsequent magnetic field orientation treatment of the formed coated film, the solvent is removed from the coated film. Next, the coated film is smoothed and cured to allow formation of a magnetic layer 30. The smoothing of the coated film is preferably accomplished by calendering treatment. It is thus possible to obtain a laminated body comprising a backcoat layer 40, support 10, non-magnetic layer 20 and magnetic layer 30 laminated in that order.

The laminated body obtained by the process described above may be cut into a desired tape-like form to obtain a magnetic tape 100. The magnetic tape 100 will normally be used in a form incorporated into a prescribed cartridge.

The embodiments described above are preferred embodiments of the invention, but the invention is not limited thereto. For example, the firing step does not need to be carried out for the first embodiment of the process for production an oxide fine particle powder. In this case, the oxide fine particle powder as obtained from the heating step may be used for the purposes mentioned above. The magnetic recording medium may also be a magnetic card, magnetic disk or the like.

### EXAMPLES

The present invention will now be explained in greater detail through the following examples, with the understanding that these examples are in no way limitative on the invention.

[Ferrite Magnetic Material: Strontium Ferrite]

### Example 1

### <Preparation of Oxide Fine Particle Powders>

After weighing out commercially available lanthanum(III) nitrate hexahydrate (La(NO₃)₃.6H₂O), strontium nitrate (Sr(NO₃)₂), zinc(II) nitrate hexahydrate (Zn(NO₃)₂.6H₂O) and iron(III) nitrate nonahydrate (Fe(NO₃)₃.9H₂O) to a molar ratio of La:Sr:Zn:Fe=0.3:0.7:0.3:11.7, they were dissolved in ion-exchanged water to obtain a starting mixture.

Next, commercially available citric acid monohydrate (C₆H₈O₇.H₂O) and ethylene glycol (HOCH₂CH₂OH) were added to the mixed aqueous solution containing each of these nitric acid salts, to a nitrate:citrate monohydrate:ethylene glycol proportion of approximately 1:5:20 as the molar ratio, to obtain a solution containing a metal-citrate complex (metal organic acid salt solution).

The solution containing the metal-citrate complex was heated and stirred at 100° C. for 6 hours for gelling to prepare a metal complex gel (metal-citrate complex gel), and then the obtained metal complex gel was dried at 150° C. for 24 hours and subsequently pulverized into a powder form to obtain a dry powder of a metal complex gel. The dry powder obtained in this manner was subjected to heat treatment using a tubular electric furnace with controllable temperature and atmosphere.

The heat treatment was carried out in a mixed gas atmosphere of air and superheated steam. The mixing ratio of the air and superheated steam was adjusted to an oxygen concentration of 10 vol %. The heating temperature and heating time were, as shown in Table 1, 200-600° C. and 2-24 hours, respectively. This produced 7 different oxide fine particle powders with different heat treatment conditions.

<Evaluation of Oxide Fine Particle Powders>

The oxide fine particle powders obtained by the aforementioned heat treatment were each observed by TEM, and the mean particle diameters of 100 primary particles and the maximum particle diameters were determined. The carbon contents in the powders were also determined by gas analysis. The results are shown in Table 1. In the table, “amorphous” indicates that the particles did not grow sufficiently to allow measurement of the particle diameter.

### Example 2

Oxide fine particle powders were prepared and evaluated in the same manner as Example 1, except that the atmosphere during heat treatment was a mixed gas of nitrogen and heated water vapor (oxygen concentration: 0 vol %) instead of the mixed gas of air and superheated steam. The evaluation results are shown in Table 1.

### Example 3

Oxide fine particle powders were prepared and evaluated in the same manner as Example 1, except that the atmosphere during heat treatment was heated water vapor alone instead of the mixed gas of air and superheated steam. The evaluation results are shown in Table 1.

### Comparative Example 1

Oxide fine particle powders were prepared and evaluated in the same manner as Example 1, except that the atmosphere during heat treatment was air alone (oxygen concentration: 21 vol %) instead of the mixed gas of air and superheated steam. The evaluation results are shown in Table 1.

### Comparative Example 2

Oxide fine particle powders were prepared and evaluated in the same manner as Example 1, except that the atmosphere during heat treatment was nitrogen alone instead of the mixed gas of air and superheated steam. The evaluation results are shown in Table 1.

TABLE 1

| Heat | | | | | | |
|---|---|---|---|---|---|---|
| treatment | | | | | | |
| conditions | | Example 1 | Example 2 | Example 3 | Comp. Ex. 1 | Comp. Ex. 2 |
| 200° C. | Mean particle | 3 | — | — | amorphous | amorphous |
| 24 hr | diameter (nm) | | | | | |
| | Maximum particle | 15 | — | — | 6 | 5 |
| | diameter (nm) | | | | | |
| | Carbon content | 3 | — | — | 11 | 12 |
| | (wt %) | | | | | |
| 250° C. | Mean particle | 4 | 2 | amorphous | — | — |
| 24 hr | diameter (nm) | | | | | |
| | Maximum particle | 16 | 11 | 12 | — | — |
| | diameter (nm) | | | | | |
| | Carbon content | 1.5 | 9.8 | 8.5 | — | — |
| | (wt %) | | | | | |
| 300° C. | Mean particle | 5 | 5 | 4 | 36 | *1 |
| 12 hr | diameter (nm) | | | | | |
| | Maximum particle | 18 | 14 | 15 | 101 | |
| | diameter (nm) | | | | | |
| | Carbon content | 0.9 | 7.9 | 6.3 | 0.9 | |
| | (wt %) | | | | | |
| 400° C. | Mean particle | 9 | 12 | 11 | 47 | *1 |
| 2 hr | diameter (nm) | | | | | |
| | Maximum particle | 23 | 21 | 24 | 124 | |
| | diameter (nm) | | | | | |
| | Carbon content | 0.5 | 4.8 | 3.5 | 0.5 | |
| | (wt %) | | | | | |
| 500° C. | Mean particle | 15 | 21 | 18 | 55 | *1 |
| 2 hr | diameter (nm) | | | | | |
| | Maximum particle | 31 | 32 | 34 | 131 | |
| | Carbon content | 0.3 | 3.1 | 2 | 0.2 | |
| | (wt %) | | | | | |
| 550° C. | Mean particle | 18 | 26 | 23 | 58 | *1 |
| 2 hr | diameter (nm) | | | | | |
| | Maximum particle | 37 | 43 | 41 | 133 | |
| | diameter (nm) | | | | | |
| | Carbon content | 0.2 | 2.5 | 1.5 | 0.2 | |
| | (wt %) | | | | | |
| 600° C. | Mean particle | 24 | 37 | 33 | 61 | *1 |
| 2 hr | diameter (nm) | | | | | |
| | Maximum particle | 45 | 58 | 48 | 134 | |
| | diameter (nm) | | | | | |
| | Carbon content | 0.2 | 2 | 1.1 | 0.2 | |
| | (wt %) | | | | | |

In the table, “—” indicates not evaluated, and “*1” indicates that combustion occurred when the oxide fine particle powder was removed from the furnace.

The results shown in Table 1 confirmed that heat treatment in a water vapor-containing atmosphere can yield fine particle powder with a sufficiently reduced carbon content, that has a fine size and contains no coarse particles. On the other hand, while the carbon content was reduced to some extent in Comparative Example 1 in which heat treatment was carried out in air, the mean particle diameter and maximum particle diameter were larger than in Examples 1-3. In Comparative Example 2, combustion sometimes occurred when the fired powder was carried out from the tubular electric furnace. This was believed to be because the organic material and decomposition products remaining in the fired powder had not been sufficiently reduced, such that oxidation reaction took place during removal, causing combustion. The effect of the oxygen concentration in the atmosphere during heat treatment was then examined.

### Examples 4-9

Oxide fine particle powders were prepared and evaluated in the same manner as Example 1, except that the atmosphere during heat treatment was prepared by varying the air, nitrogen and superheated steam mixing ratio. Specifically, the superheated steam content was kept constant (10 vol %) and the air/nitrogen mixing volumes were adjusted for oxygen concentrations of 0-20 vol % in the atmosphere. For Examples 7-9, oxygen was used instead of air to adjust the oxygen concentration in the atmosphere. The oxygen concentration in the atmospheres used for heat treatment in Examples 4-9, and the results of evaluating the oxide fine particle powders, are summarized in Table 2.

TABLE 2

| | | Example 4 | Example 5 | Example 6 | Example 7 | Example 8 | Example 9 |
|---|---|---|---|---|---|---|---|
| Heat treatment | | Oxygen concentration | | | | | |
| conditions | | 0 vol % | 0.1 vol % | 1 vol % | 10 vol % | 20 vol % | 25 vol % |
| 200° C. | Mean particle diameter | — | amorphous | 3 | 3 | 3 | 8 |
| 24 hr | (nm) | | | | | | |
| | Maximum particle | — | 10 | 10 | 15 | 16 | 22 |
| | diameter (nm) | | | | | | |
| | Carbon content (wt %) | — | 4.9 | 4.2 | 3 | 3.2 | — |
| 250° C. | Mean particle diameter | 2 | 2.5 | 3 | 4 | 3.5 | 16 |
| 24 hr | (nm) | | | | | | |
| | Maximum particle | 11 | 12 | 14 | 16 | 18 | 61 |
| | diameter (nm) | | | | | | |
| | Carbon content (wt %) | 9.8 | 3.1 | 2.3 | 1.5 | 1.3 | 7.8 |
| 300° C. | Mean particle diameter | 5 | 3 | 4 | 5 | 5 | — |
| 12 hr | (nm) | | | | | | |
| | Maximum particle | 14 | 15 | 16 | 18 | 25 | — |
| | diameter (nm) | | | | | | |
| | Carbon content (wt %) | 7.9 | 2 | 1.6 | 0.9 | 0.8 | — |
| 400° C. | Mean particle diameter | 12 | 8 | 9 | 9 | 18 | — |
| 2 hr | (nm) | | | | | | |
| | Maximum particle | 21 | 22 | 24 | 23 | 55 | — |
| | diameter (nm) | | | | | | |
| | Carbon content (wt %) | 4.8 | 1.4 | 1 | 0.5 | 0.3 | — |
| 500° C. | Mean particle diameter | 21 | 16 | 15 | 15 | — | — |
| 2 hr | (nm) | | | | | | |
| | Maximum particle | 32 | 33 | 34 | 31 | — | — |
| | diameter (nm) | | | | | | |
| | Carbon content (wt %) | 3.1 | 1 | 0.6 | 0.3 | — | — |
| 550° C. | Mean particle diameter | 26 | 21 | 19 | 18 | — | — |
| 2 hr | (nm) | | | | | | |
| | Maximum particle | 43 | 42 | 41 | 37 | — | — |
| | diameter (nm) | | | | | | |
| | Carbon content (wt %) | 2.5 | 0.8 | 0.4 | 0.2 | — | — |
| 600° C. | Mean particle diameter | 37 | 28 | 24 | 24 | — | — |
| 2 hr | (nm) | | | | | | |
| | Maximum particle | 58 | 53 | 55 | 45 | — | — |
| | diameter (nm) | | | | | | |
| | Carbon content (wt %) | 2 | 0.6 | 0.2 | 0.2 | — | — |

In the table, “—” indicates not evaluated.

From the results in Table 2 it was confirmed that the carbon content can be reduced even with a low oxygen concentration. Also, it was confirmed that the mean particle diameter and maximum particle diameter tended to increase with higher oxygen concentration. This was attributed to grain growth that occurred due to local combustion.

### Example 10

Dry powders of metal complex gels were obtained in the same manner as Example 1. Each of the obtained dry powders was subjected to heat treatment primarily for degradation of the organic acids, using a tubular electric furnace with controllable temperature and atmosphere (first step). Next, the same tubular electric furnace was used for heat treatment primarily for decarbonization, in an air atmosphere (oxygen concentration: 21 vol %) (second step), to obtain strontium ferrite powder. The temperature and oxygen concentration in the first and second steps in Example 10 were adjusted as shown in Tables 3 to 8 below. The oxygen concentration in the atmosphere for the first step was adjusted by varying the relative flow rates of air and nitrogen gas. An oxygen concentration of “0 ppm” in the atmosphere means that only nitrogen gas was supplied.

The powders obtained after the first step and after the second step were each observed by TEM, and the mean particle diameter for 100 observed primary particles and the maximum particle diameters were determined. The carbon contents in the powders were also determined by gas analysis. The results are summarized in Tables 3 to 8. In the tables, “amorphous” indicates that the particles did not grow sufficiently to allow measurement of the particle diameter.

TABLE 3

| | | | | Heat treatment conditions in | | | | |
|---|---|---|---|---|---|---|---|---|
| | | | | first step (Top row: | | | | |
| | | | | Temperature (° C.), bottom row: | | | | |
| | | | | Oxygen concentration (ppm)) | | | | |
| | | Particle diameters and carbon | | 200 | 300 | 400 | 500 | 600 |
| | | contents of powder after each step | | 50 | 50 | 50 | 50 | 50 |
| Heat | 200° C. | After | Mean particle diameter (nm) | 21 | 14 | 17 | 20 | 24 |
| treatment | | second | Maximum particle diameter | 93 | 121 | 159 | 183 | 192 |
| conditions | | step | (nm) | | | | | |
| in second | | | Carbon content (wt %) | 0.5 | 0.4 | 0.3 | 0.3 | 0.3 |
| step (in air) | 300° C. | | Mean particle diameter (nm) | 25 | 15 | 18 | 22 | 27 |
| | | | Maximum particle diameter | 121 | 61 | 75 | 90 | 112 |
| | | | (nm) | | | | | |
| | | | Carbon content (wt %) | 0.3 | 0.1 | 0.1 | 0.1 | 0.1 |
| | 400° C. | | Mean particle diameter (nm) | 38 | 18 | 22 | 29 | 35 |
| | | | Maximum particle diameter | 159 | 69 | 85 | 98 | 121 |
| | | | (nm) | | | | | |
| | | | Carbon content (wt %) | 0.2 | 0.1 | 0.1 | 0.1 | 0.1 |
| | 500° C. | | Mean particle diameter (nm) | 55 | 26 | 34 | 41 | 51 |
| | | | Maximum particle diameter | 183 | 88 | 100 | 119 | 136 |
| | | | (nm) | | | | | |
| | | | Carbon content (wt %) | 0.1 | 0.1 | 0.1 | 0.1 | 0.1 |
| | 600° C. | | Mean particle diameter (nm) | 78 | 38 | 48 | 60 | 72 |
| | | | Maximum particle diameter | 192 | 116 | 135 | 154 | 171 |
| | | | (nm) | | | | | |
| | | | Carbon content (wt %) | 0.1 | 0.1 | 0.1 | 0.1 | 0.1 |

TABLE 4

| | | | | Heat treatment conditions | | | | |
|---|---|---|---|---|---|---|---|---|
| | | | | in first step (Top row: | | | | |
| | | | | Temperature (° C.), bottom row: | | | | |
| | | Particle diameters and carbon | | Oxygen concentration (ppm)) | | | | |
| | | contents of powder | | 200 | 300 | 400 | 500 | 600 |
| | | after each step | | 200 | 200 | 200 | 200 | 200 |
| Heat | 200° C. | After | Mean particle | 24 | 14 | 18 | 22 | 27 |
| treatment | | second | diameter (nm) | | | | | |
| conditions | | step | Maximum particle | 96 | 58 | 71 | 88 | 114 |
| in second | | | diameter (nm) | | | | | |
| step (in air) | | | Carbon content | 0.4 | 0.3 | 0.2 | 0.2 | 0.2 |
| | | | (wt %) | | | | | |
| | 300° C. | | Mean particle | 26 | 14 | 18 | 22 | 29 |
| | | | diameter (nm) | | | | | |
| | | | Maximum particle | 115 | 61 | 73 | 91 | 117 |
| | | | diameter (nm) | | | | | |
| | | | Carbon content | 0.2 | 0.1 | 0.1 | 0.1 | 0.1 |
| | | | (wt %) | | | | | |
| | 400° C. | | Mean particle | 33 | 16 | 22 | 28 | 36 |
| | | | diameter (nm) | | | | | |
| | | | Maximum particle | 146 | 70 | 85 | 101 | 125 |
| | | | diameter (nm) | | | | | |
| | | | Carbon content | 0.1 | 0.1 | 0.1 | 0.1 | 0.1 |
| | | | (wt %) | | | | | |
| | 500° C. | | Mean particle | 45 | 25 | 33 | 39 | 47 |
| | | | diameter (nm) | | | | | |
| | | | Maximum particle | 166 | 85 | 100 | 119 | 139 |
| | | | diameter (nm) | | | | | |
| | | | Carbon content | 0.1 | 0.1 | 0.1 | 0.1 | 0.1 |
| | | | (wt %) | | | | | |
| | 600° C. | | Mean particle | 72 | 37 | 48 | 56 | 67 |
| | | | diameter (nm) | | | | | |
| | | | Maximum particle | 182 | 110 | 132 | 153 | 172 |
| | | | diameter (nm) | | | | | |
| | | | Carbon content (wt %) | 0.1 | 0.1 | 0.1 | 0.1 | 0.1 |

TABLE 5

| | | | | Heat treatment conditions in first | | | | |
|---|---|---|---|---|---|---|---|---|
| | | | | step (Top row: Temperature (° C.), | | | | |
| | | | | bottom row: Oxygen | | | | |
| | | Particle diameters and carbon | | concentration (ppm)) | | | | |
| | | contents of powder | | 200 | 300 | 400 | 500 | 600 |
| | | after each step | | 2000 | 2000 | 2000 | 2000 | 2000 |
| Heat | 200° C. | After | Mean particle | 24 | 15 | 19 | 24 | 32 |
| treatment | | second | diameter (nm) | | | | | |
| conditions | | step | Maximum particle | 85 | 90 | 104 | 138 | 196 |
| in second | | | diameter (nm) | | | | | |
| step (in air) | | | Carbon content | 0.4 | 0.3 | 0.2 | 0.2 | 0.2 |
| | | | (wt %) | | | | | |
| | 300° C. | | Mean particle | 24 | 16 | 20 | 26 | 33 |
| | | | diameter (nm) | | | | | |
| | | | Maximum particle | 90 | 57 | 83 | 98 | 121 |
| | | | diameter (nm) | | | | | |
| | | | Carbon content | 0.2 | 0.1 | 0.1 | 0.1 | 0.1 |
| | | | (wt %) | | | | | |
| | 400° C. | | Mean particle | 30 | 19 | 23 | 31 | 38 |
| | | | diameter (nm) | | | | | |
| | | | Maximum particle | 104 | 68 | 94 | 107 | 135 |
| | | | diameter (nm) | | | | | |
| | | | Carbon content | 0.1 | 0.1 | 0.1 | 0.1 | 0.1 |
| | | | (wt %) | | | | | |
| | 500° C. | | Mean particle | 46 | 28 | 37 | 44 | 51 |
| | | | diameter (nm) | | | | | |
| | | | Maximum particle | 138 | 89 | 112 | 135 | 155 |
| | | | diameter (nm) | | | | | |
| | | | Carbon content | 0.1 | 0.1 | 0.1 | 0.1 | 0.1 |
| | | | (wt %) | | | | | |
| | 600° C. | | Mean particle | 74 | 47 | 60 | 65 | 69 |
| | | | diameter (nm) | | | | | |
| | | | Maximum particle | 196 | 122 | 148 | 185 | 205 |
| | | | diameter (nm) | | | | | |
| | | | Carbon content | 0.1 | 0.1 | 0.1 | 0.1 | 0.1 |
| | | | (wt %) | | | | | |

TABLE 6

| | | | | Heat treatment conditions in first step | | | | |
|---|---|---|---|---|---|---|---|---|
| | | | | (Top row: Temperature (° C.), bottom | | | | |
| | | Particle diameters and | | row: Oxygen concentration (ppm)) | | | | |
| | | carbon contents of | | 200 | 300 | 400 | 500 | 600 |
| | | powder after each step | | 20000 | 20000 | 20000 | 20000 | 20000 |
| Heat | 200° C. | After | Mean particle | 39 | 43 | 51 | 57 | 68 |
| treatment | | second | diameter (nm) | | | | | |
| conditions | | step | Maximum particle | 101 | 111 | 125 | 143 | 160 |
| in second | | | diameter (nm) | | | | | |
| step (in air) | | | Carbon content (wt %) | 0.1 | 0.1 | 0.1 | 0.1 | 0.1 |
| | 300° C. | | Mean particle | 41 | 44 | 53 | 59 | 72 |
| | | | diameter (nm) | | | | | |
| | | | Maximum particle | 105 | 111 | 124 | 145 | 162 |
| | | | diameter (nm) | | | | | |
| | | | Carbon content (wt %) | 0.1 | 0.1 | 0.1 | 0.1 | 0.1 |
| | 400° C. | | Mean particle | 46 | 51 | 57 | 64 | 77 |
| | | | diameter (nm) | | | | | |
| | | | Maximum particle | 112 | 119 | 130 | 152 | 169 |
| | | | diameter (nm) | | | | | |
| | | | Carbon content (wt %) | 0.1 | 0.1 | 0.1 | 0.1 | 0.1 |
| | 500° C. | | Mean particle | 56 | 60 | 66 | 73 | 83 |
| | | | diameter (nm) | | | | | |
| | | | Maximum particle | 132 | 136 | 148 | 170 | 186 |
| | | | diameter (nm) | | | | | |
| | | | Carbon content (wt %) | 0.1 | 0.1 | 0.1 | 0.1 | 0.1 |
| | 600° C. | | Mean particle | 72 | 73 | 79 | 85 | 89 |
| | | | diameter (nm) | | | | | |
| | | | Maximum particle | 182 | 183 | 192 | 207 | 227 |
| | | | diameter (nm) | | | | | |
| | | | Carbon content (wt %) | 0.1 | 0.1 | 0.1 | 0.1 | 0.1 |

TABLE 7

| | | | | Heat treatment conditions in first step | | | | | | | |
|---|---|---|---|---|---|---|---|---|---|---|---|
| | | | | (Top row: Temperature (° C.), | | | | | | | |
| | | Particle diameters and | | bottom row: Oxygen concentration (ppm)) | | | | | | | |
| | | carbon contents of | | 200 | 200 | 200 | 200 | 300 | 300 | 300 | 300 |
| | | powder after each step | | 50 | 200 | 2000 | 20000 | 50 | 200 | 2000 | 20000 |
| Heat | 200° C. | After | Mean particle | 20 | 24 | 24 | 39 | 14 | 14 | 15 | 43 |
| treatment | | second | diameter (nm) | | | | | | | | |
| conditions | | step | Maximum particle | 93 | 96 | 85 | 101 | 121 | 58 | 90 | 111 |
| in second | | | diameter (nm) | | | | | | | | |
| step (in | | | Carbon content | 0.5 | 0.4 | 0.4 | 0.1 | 0.4 | 0.3 | 0.3 | 0.1 |
| air) | | | (wt %) | | | | | | | | |
| | 300° C. | | Mean particle | 25 | 26 | 24 | 41 | 15 | 14 | 16 | 44 |
| | | | diameter (nm) | | | | | | | | |
| | | | Maximum particle | 121 | 115 | 90 | 105 | 61 | 61 | 57 | 111 |
| | | | diameter (nm) | | | | | | | | |
| | | | Carbon content (wt %) | 0.3 | 0.2 | 0.2 | 0.1 | 0.1 | 0.1 | 0.1 | 0.1 |
| | 400° C. | | Mean particle | 38 | 33 | 30 | 46 | 18 | 16 | 19 | 51 |
| | | | diameter (nm) | | | | | | | | |
| | | | Maximum particle | 159 | 146 | 104 | 112 | 69 | 70 | 68 | 119 |
| | | | diameter (nm) | | | | | | | | |
| | | | Carbon content (wt %) | 0.2 | 0.1 | 0.1 | 0.1 | 0.1 | 0.1 | 0.1 | 0.1 |
| | 500° C. | | Mean particle | 55 | 45 | 46 | 56 | 26 | 25 | 28 | 60 |
| | | | diameter (nm) | | | | | | | | |
| | | | Maximum particle | 183 | 166 | 138 | 132 | 88 | 85 | 89 | 136 |
| | | | diameter (nm) | | | | | | | | |
| | | | Carbon content (wt %) | 0.1 | 0.1 | 0.1 | 0.1 | 0.1 | 0.1 | 0.1 | 0.1 |
| | 600° C. | | Mean particle | 78 | 72 | 74 | 72 | 38 | 37 | 47 | 73 |
| | | | diameter (nm) | | | | | | | | |
| | | | Maximum particle | 192 | 182 | 196 | 182 | 116 | 110 | 122 | 183 |
| | | | diameter (nm) | | | | | | | | |
| | | | Carbon content (wt %) | 0.1 | 0.1 | 0.1 | 0.1 | 0.1 | 0.1 | 0.1 | 0.1 |

TABLE 8

| | | | | Heat treatment conditions in first step | | | | | |
|---|---|---|---|---|---|---|---|---|---|
| | | | | (Top row: Temperature (° C.), | | | | | |
| | | Particle diameters and | | bottom row: Oxygen concentration (ppm)) | | | | | |
| | | carbon contents of | | 150 | 200 | 250 | 150 | 200 | 250 |
| | | powder after each step | | 0 | 0 | 0 | 10 | 10 | 10 |
| Heat | 200° C. | After | Mean particle | *2 | *2 | 6 | *2 | 19 | 16 |
| treatment | | second | diameter (nm) | | | | | | |
| conditions | | step | Maximum | 13 | 21 | 32 | 29 | 34 | 51 |
| in second | | | particle diameter | | | | | | |
| step (in air) | | | (nm) | | | | | | |
| | | | Carbon content (wt %) | 28 | 21 | 9.7 | 25 | 19 | 7.6 |
| | 300° C. | | Mean particle | 61 | 34 | 25 | 56 | 34 | 28 |
| | | | diameter (nm) | | | | | | |
| | | | Maximum | 143 | 96 | 74 | 132 | 85 | 74 |
| | | | particle diameter (nm) | | | | | | |
| | | | Carbon content | 4.3 | 0.9 | 0.3 | 3.7 | 0.5 | 0.2 |
| | | | (wt %) | | | | | | |
| | 400° C. | | Mean particle | 99 | 80 | 44 | 104 | 65 | 49 |
| | | | diameter (nm) | | | | | | |
| | | | Maximum | 247 | 215 | 143 | 234 | 191 | 125 |
| | | | particle diameter (nm) | | | | | | |
| | | | Carbon content | 0.8 | 0.5 | 0.2 | 1.1 | 0.3 | 0.1 |
| | | | (wt %) | | | | | | |
| | 500° C. | | Mean particle | 142 | 98.6 | 76 | 144 | 108 | 73 |
| | | | diameter (nm) | | | | | | |
| | | | Maximum | 315 | 267 | 165 | 294 | 254 | 160 |
| | | | particle diameter (nm) | | | | | | |
| | | | Carbon content (wt %) | 0.1 | 0.1 | 0.1 | 0.1 | 0.1 | 0.1 |
| | 600° C. | | Mean particle | 172 | 143 | 108 | 168 | 143 | 103 |
| | | | diameter (nm) | | | | | | |
| | | | Maximum | 323 | 270 | 197 | 321 | 275 | 194 |
| | | | particle diameter (nm) | | | | | | |
| | | | Carbon content (wt %) | 0.1 | 0.1 | 0.1 | 0.1 | 0.1 | 0.1 |

In the table, “*2” means amorphous.

### Comparative Example 3

Strontium ferrite powder was obtained in the same manner as Example 10, except that the heat treatment of the dry powder of a metal complex gel was carried out by a single step with a temperature of 300° C. and an air atmosphere (oxygen concentrate: 21 vol %). As a result, the mean particle diameter of the obtained powder was 90 nm, and the maximum particle diameter was 310 nm. The carbon content was no greater than 0.1 wt %. Thus, the strontium ferrite powder obtained in Comparative Example 3 had a larger mean particle diameter compared to the powder of Example 10 described above, and contained coarse particles with the aforementioned maximum particle diameter.

(Observation of Strontium Ferrite Powder)

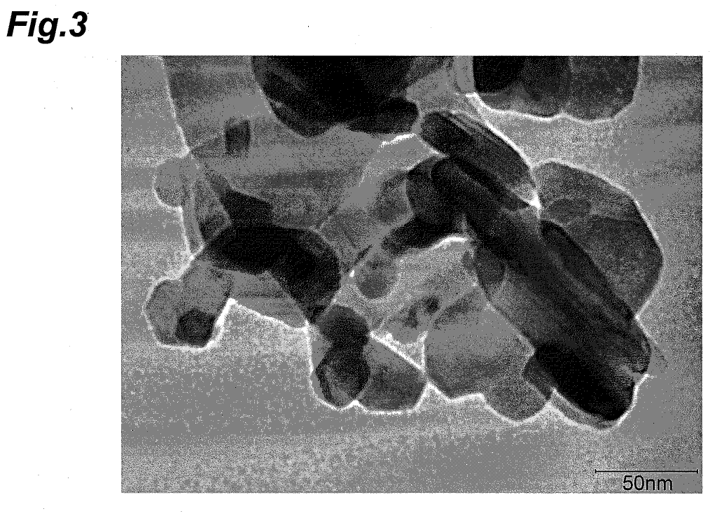

FIG. 3 and FIG. 4 show the results of transmission electron microscope (TEM) observation of the strontium ferrite powder obtained with heat treatment conditions of 300° C. and an oxygen concentration of 200 ppm for the first step and heat treatment conditions of air, 300° C. for the second step in Example 10, and the strontium ferrite powder obtained in Comparative Example 3. FIG. 3 is a TEM photograph of the strontium ferrite powder of Example 10, and FIG. 4 is a TEM photograph of the strontium ferrite powder of Comparative Example 3. As seen in FIGS. 3 and 4, it was confirmed that the strontium ferrite powder produced in Example 10 had a smaller particle diameter than that produced in Comparative Example 3.

[Dielectric Material: Barium Titanate]

### Example 11

After adding 10 parts by weight of citric acid (C₆H₈O₇.H₂O) to 8 parts by weight of titanium butoxide (Ti(OC₄H₉)₄ as a Ti alkoxide, ammonia water was added to adjust the pH to 5, to prepare a titanium citrate aqueous solution. Also, barium carbonate was dissolved in a 2.5 M citric acid aqueous solution to prepare a barium citrate aqueous solution. The obtained titanium citrate and barium citrate were mixed in a Ba:Ti molar ratio of 1:1 and stirred, and the pH was adjusted to 2.5 with ammonia water. The mixture was then allowed to stand for 2 hours to obtain a precipitate of a compound citric acid salt of barium and titanium (BaTi(C₆H₆O₇)₃.6H₂O) as a metal complex gel.

The precipitate was filtered and washed, and after drying at 100° C. for 24 hours, the obtained dried product was pulverized into a powder to obtain a dry powder of a metal complex gel. The dry powder obtained in this manner was subjected to heat treatment, accomplishing primarily degradation of the organic acids, using a tubular electric furnace with controllable temperature and atmosphere (first step). Next, the same tubular electric furnace was used for heat treatment primarily for decarbonization, in an air atmosphere (oxygen concentration: 21 vol %) to obtain barium titanate powder (second step). The heat treatment conditions for the first and second steps of Example 11 were varied with different temperatures and oxygen concentrations, as shown in Table 9 below. The oxygen concentration in the atmosphere for the first step was adjusted by varying the relative flow rates of air and nitrogen gas.

The powders obtained after the first step and after the second step were each observed by TEM, and the mean particle diameter of 100 observed primary particles and the maximum particle diameters were determined. The carbon contents of the powders were determined using a chemical analysis (carbon/sulfur) apparatus. The results are shown in Table 9. In the table, “amorphous” indicates that the particles had not grown sufficiently to allow measurement of the particle diameter.

TABLE 9

| | | | | Heat treatment conditions | | | | |
|---|---|---|---|---|---|---|---|---|
| | | | | in first step (Top row: | | | | |
| | | | | Temperature (° C.), bottom | | | | |
| | | Particle diameters | | row: Oxygen concentration (ppm)) | | | | |
| | | and carbon contents | | 300 | 300 | 300 | 300 | 300 |
| | | of powder after each step | | 1 | 50 | 200 | 2000 | 20000 |
| | | After first | Mean particle diameter (nm) | *2 | 4 | 5 | 7 | 23 |
| | | step | Maximum particle diameter | 5 | 6 | 10 | 32 | 142 |
| | | | (nm) | | | | | |
| | | | Carbon content (wt %) | 5.3 | 1.6 | 1.5 | 1.2 | 0.4 |
| Heat | 250° C. | After | Mean particle diameter (nm) | 21 | 12 | 13 | 15 | 41 |
| treatment | | second | Maximum particle diameter | 114 | 22 | 25 | 37 | 154 |
| conditions | | step | (nm) | | | | | |
| in second | | | Carbon content (wt %) | 0.5 | 0.3 | 0.3 | 0.3 | 0.3 |
| step (in air) | 300° C. | | Mean particle diameter (nm) | 35 | 18 | 19 | 21 | 47 |
| | | | Maximum particle diameter | 124 | 25 | 29 | 33 | 164 |
| | | | (nm) | | | | | |
| | | | Carbon content (wt %) | 0.3 | 0.1 | 0.1 | 0.1 | 0.1 |
| | 400° C. | | Mean particle diameter (nm) | 88 | 25 | 27 | 29 | 75 |
| | | | Maximum particle diameter | 163 | 38 | 41 | 46 | 181 |
| | | | (nm) | | | | | |
| | | | Carbon content (wt %) | 0.2 | 0.1 | 0.1 | 0.1 | 0.1 |
| | 500° C. | | Mean particle diameter (nm) | 138 | 42 | 44 | 48 | 96 |
| | | | Maximum particle diameter | 181 | 54 | 60 | 72 | 205 |
| | | | (nm) | | | | | |
| | | | Carbon content (wt %) | 0.1 | 0.1 | 0.1 | 0.1 | 0.1 |
| | 600° C. | | Mean particle diameter (nm) | 164 | 58 | 60 | 63 | 108 |
| | | | Maximum particle diameter | 237 | 89 | 91 | 98 | 226 |
| | | | (nm) | | | | | |
| | | | Carbon content (wt %) | 0.1 | 0.1 | 0.1 | 0.1 | 0.1 |

In the table, “*2” means amorphous.

[Oxide Superconductor]

### Example 12

To 10 mmol of yttrium nitrate (Y(NO₃)₃.6H₂O), 20 mmol of barium carbonate (BaCO₃) and 30 mmol of copper nitrate (Cu(NO₃)₂.3H₂O) there was added 150 ml of ion-exchanged water and 45 mmol of citric acid (H₃(C₆H₅O₇).H₂O), and the mixture was dispersed. After adding 1000 mmol of ethylene glycol (HOCH₂CH₂OH) to the dispersion, it was heated to 90° C. and further heated to dissolution while stirring vigorously.

The obtained solution was then heated to 120° C. for concentration to obtain a colloidal solution, and subsequently heated to 140-220° C. for complex polymerization to prepare a metal complex gel. The viscosity increased as the polymerization reaction proceeded, and therefore stirring was suspended and heating alone carried out, at an appropriate timing. The metal complex gel was then cooled to room temperature, and the obtained mass was pulverized using a mortar to obtain a dry powder of a metal complex gel.

The dry powder was then subjected to heat treatment wherein it was heated at 5° C./min using a tubular electric furnace with controllable atmosphere, while supplying a mixed gas of air and nitrogen with the oxygen concentration at 200 ppm, and kept at 330° C. for 2 hours, after which the temperature was lowered at 5° C./min (first step). This accomplished degradation and firing of the organic material in the dry powder of a metal complex gel. At this stage, the organic material was degraded but contained abundant residual carbon.

The obtained fired powder was then subjected to heat treatment wherein it was heated at 5° C./min while supplying air and held at 340° C. for 2 hours, and then cooled at 5° C./min, for decarbonizing firing (second step). The residual carbon was thus removed. The obtained powder was pulverized to obtain fine oxide fine particle powder. The primary particle size of the powder was 50 nm, and it contained no coarse particles exceeding 100 nm. The powder also had a carbon content of no greater than 5 wt %, and the BET specific surface area was 45 m²/g.

The powder was then subjected to press molding with a disc and main firing at 890° C. for 24 hours in an air atmosphere, to obtain a satisfactory oxide superconductor with a value of Tc=89.5K.

[Fluorescent Material]

### Example 13

After adding 10 mmol of yttrium nitrate (Y(NO₃)₃.6H₂O), 0.4 mmol of europium nitrate (Eu(NO₃)₃.6H₂O) and 100 mmol of ethylene glycol (HOCH₂CH₂OH) to ion-exchanged water, the mixture was stirred to complete dissolution to obtain a colorless transparent solution. The obtained solution was then heated to 120° C. for concentration to form a colloidal solution. Heating was continued for polymerization reaction, and the final reaction product was evaporated to dryness to obtain a dry powder of a metal complex gel.

The dry powder was subjected to heat treatment wherein it was heated at 5° C./min using a tubular electric furnace with controllable atmosphere, while supplying a mixed gas of air and nitrogen with the oxygen concentration at 200 ppm, and kept at 320° C. for 2 hours, after which the temperature was lowered at 5° C./min (first step). This accomplished degradation and firing of the organic material in the solid to obtain amorphous Y₂O₃:Eu.

The obtained fired powder was then subjected to heat treatment wherein it was heated at 5° C./min while supplying air and held at 340° C. for 2 hours, and then cooled at 5° C./min (second step). The residual carbon was thus removed.

The powder obtained in this manner had a primary particle size of 40 nm and it contained no coarse particles exceeding 100 nm, while the BET value was 50 m²/g. The powder was then fired in air at 700° C. for 2 hours to obtain a Y₂O₃:Eu fluorescent material.

[Li Cell Positive Electrode Material]

### Example 14

After adding 50 ml of ethylene glycol (HOCH₂CH₂OH) to 0.1 mol (24.88 g) of nickel acetate (Ni(CH₃COO)₂.4H₂O) and 0.102 mol (0.673 g) of lithium acetate (CH₃COOLi), the mixture was stirred to dissolution while heating at 80° C.

The obtained solution was then heated to 120° C. for concentration to form a colloidal solution, and heating was continued for polymerization reaction to obtain a viscous liquid. Heating was further continued for solidification of the viscous liquid, to obtain a dry powder of a metal complex gel.

The dry powder was heated at 5° C./min using a tubular electric furnace with controllable atmosphere, while supplying a mixed gas of air and nitrogen with the oxygen concentration at 200 ppm, and kept at 320° C. for 2 hours, after which the temperature was lowered at 5° C./min (first step). This heat treatment accomplished degradation and firing of the organic material in the solid. At this stage, the organic material was degraded but contained abundant residual carbon.

The fired powder was then heated at 5° C./min while supplying air and held at 340° C. for 2 hours, and then cooled at 5° C./min (second step). The residual carbon was removed by this heat treatment. The obtained powder was pulverized to obtain fine oxide fine particle powder. The primary particle size of the powder was 40 nm, and it contained no coarse particles exceeding 100 nm. The powder also had a carbon content of no greater than 5 wt %, and the BET specific surface area was 55 m²/g.

The obtained oxide fine particle powder was then fired at 750° C. for 5 hours in an oxygen stream to obtain LiNiO₂ having the desired crystalline form (third step).

What is claimed is:

1. A process for production of an oxide fine particle powder, comprising:
a heating step in which a dry powder of a metal complex gel is heat treated to obtain an oxide fine particle powder,
wherein at least part of the heating step is carried out in a water vapor-containing atmosphere.

2. The process for production of an oxide fine particle powder according to claim 1, wherein the water vapor-containing atmosphere in the heating step further contains oxygen.

3. The process for production an oxide fine particle powder according to claim 1, wherein the dry powder is subject to heat treatment at 250-400° C. in the heating step.

4. The process for production of an oxide fine particle powder according to claim 1, which comprises a firing step in which the oxide fine particle powder obtained in the heating step is subjected to heat treatment at a higher temperature than the heating step.

5. A process for production of an oxide fine particle powder, comprising:
a first step in which dry powder of a metal complex gel is heat treated in a first atmosphere to obtain fired powder, and
a second step in which the fired powder is heat treated in a second atmosphere with a higher oxygen concentration than the first atmosphere to obtain oxide fine particle powder.

6. The process for production of an oxide fine particle powder according to claim 5, wherein in the first step, the oxygen concentration in the first atmosphere is 0-2000 ppm and the dry powder is heated at 200-500° C.

7. The process for production of an oxide fine particle powder according to claim 5, wherein in the first step, the oxygen concentration in the first atmosphere is 0-50 ppm and the dry powder is heated at 200-300° C.

8. The process for production an oxide fine particle powder according to claim 5, wherein in the second step, the first fired powder is heated to 300-500° C.

9. The process for production of an oxide fine particle powder according to claim 5, which further comprises a third step in which the oxide fine particle powder obtained in the second step is further heat treated in such a manner that grain growth does not occur.

10. An oxide fine particle powder having a primary particle with a mean particle diameter of 1-50 nm, containing no particles with particle diameters exceeding 100 nm, having a specific surface area of 30 m²/g or greater and having a carbon content of no greater than 0.5 wt %.

11. An oxide fine particle powder obtained by the production process according to claim 1.

12. An oxide fine particle powder obtained by the production process according to claim 5.

13. A magnetic recording medium comprising a magnetic layer that contains an oxide fine particle powder according to claim 10.

14. A magnetic recording medium comprising a magnetic layer that contains an oxide fine particle powder according to claim 11.

15. A magnetic recording medium comprising a magnetic layer that contains an oxide fine particle powder according to claim 12.
